(19) United States
(12) Patent Application Publication
(10) Pub. No.: US 2004/0107151 A1
(43) Pub. Date: Jun. 3, 2004

(54) Splitting an order line item into multiple deliveries

(76) Inventor: Arno Diego Bruns, Karlsruhe (DE)

Correspondence Address: Fish & Richardson P.C., 225 Franklin Street, Boston, MA, 02110-2804, US

(21) Appl. No.: 10/309,409

(22) Filed: Dec. 2, 2002

(51) Int. Cl. G06F 17/60

(52) U.S. Cl. 705/29

(57) ABSTRACT

A method of splitting a line item, includes storing a first criteria, for splitting the line item into a plurality of deliveries, and a second criteria. The method also includes generating the plurality of deliveries according to the first criteria. The method can also include determining if the line item satisfies the second criteria. The method can further include generating the plurality of deliveries when the line item satisfies the second criteria.

### TECHNICAL FIELD

This disclosure relates to order fulfillment and, in particular, shipment planning.

### BACKGROUND

Typically, a sales order includes a header that includes the name of a customer and one or more line items. Generally, each line item includes a quantity of a product, a unit price, a total price, a date the customer needs the product, a destination where to ship the product, and a shipping location from where the product is shipped, e.g., a warehouse. In some instances, there is more than one shipping location. In other instances, the amount of product shipped is limited by supply or capacity. For example, the number of tons of coal to ship to a customer is constrained by the tonnage capacity of the trucks that deliver the coal.

### SUMMARY

In one aspect, the invention is a method of splitting a line item in an order. The method includes storing a first criteria, for splitting the line item into a plurality of deliveries, and a second criteria. The method also includes generating the plurality of deliveries according to the first criteria.

In another aspect the invention is an apparatus. The apparatus includes a memory that stores executable instructions for splitting a line item into a plurality of deliveries. The apparatus also includes a processor that executes the instructions to store a first criteria, for splitting the line item into a plurality of deliveries, and a second criteria. The processor also executes instructions to generate the plurality of deliveries in accordance with the first criteria.

In a further aspect the invention is an article. The article includes a machine-readable medium that stores executable instructions for splitting a line item into a plurality of deliveries. The instructions cause a machine to store a first criteria, for splitting the line item into a plurality of deliveries, and a second criteria; and to generate the plurality of deliveries according to the first criteria.

One or more of the aspects above may have one or more of the following features. The second criteria may include a threshold value. For example, the threshold value can include units of weight. In another example, the threshold value includes a quantity.

In addition, the first criteria may include a delivery parameter. For example, the delivery parameter can include units of weight. In another example, the delivery parameter includes a quantity.

Each aspect may include determining if the line item meets the threshold value. Delivering the plurality of deliveries may include delivering at least one shipment in an increment equal to the delivery parameter. Generating the plurality of deliveries may also include determining if the line item satisfies the criteria and splitting the line item into the plurality of deliveries when the line item satisfies the criteria.

One or more of the aspects above have one or more of the following advantages. By taking a line item and splitting deliveries, a customer will receive products faster because the delivery is optimized. In addition, the manufacturer can optimize throughput by eliminating blockages of product due to delivery constraints. By allowing a user to establish the criteria for splitting, the user can determine what the criteria are and whether the criteria are used automatically or manually. Thus, the user can tailor the criteria to meet their ongoing changes in production requirements. Automatically generating the criteria allows for less oversight and maintenance.

### DESCRIPTION OF THE DRAWINGS

FIG. 1 is a block diagram of an order fulfillment system.

FIG. 2 is a process for splitting line items.

FIG. 3 is an example of a process for inputting criteria.

FIG. 4 is a block diagram of a computer system on which the process of FIG. 2 may be implemented.

### DESCRIPTION

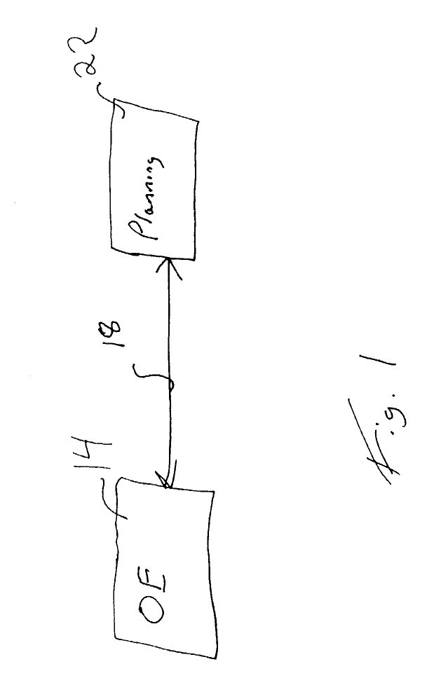

Referring to FIG. 1, an order fulfillment system 10 includes an order entry and execution function 14 and a planning function 22 connected by a core interface (CIF) 18. Order entry and execution function 14 receives sales orders that contain a customer's delivery requirements. The delivery requirements include a quantity of a product and a date the customer expects to receive the product. Order entry and execution function 14 checks the availability of stock and schedules the line items where stock is or will be available. The sales order information is duplicated via CIF 18 into planning function 22 for planning. When the planned deliveries are received back from planning function 22, order entry and execution function 14 executes the deliveries.

Planning function 22 plans the availability of material to meet customer orders or the availability of capacity to deliver the customer orders. For example, planning function 22 plans the amount of material that will be available at certain times or planning function 22 plans the availability of transportation to ship the product to a customer once it is available.

Planning function 22 plans deliveries based on the delivery requirements, the availability of on-hand of material (or capacity) and the scheduled replenishment of material into stock (or capacity).

In some cases, the line item exceeds the amount of material available or the amount of capacity for shipment. For example, a customer X orders 50 tons of coal for delivery next week. The only available trucks to deliver coal next week are a 25-ton capacity truck at plant A and a 25-ton capacity truck at plant B. In another example, customer X orders 50 widgets. 25 widgets are at warehouse A and 25 widgets are at warehouse B.

In each of the above examples, the orders would not ship automatically. The line items would need to be amended manually to allow for shipment. For example, in the case of the widgets sales order, the line item is changed from 50 units to 25 units and a new line item is generated that has 25 units. Also, the new line item can be given a higher priority to jump the backlog of line items previously entered.

As will be described below, a process 30 within planning function 22 splits the line items so that the line item is not pending an available quantity or available capacity that matches the line item requirements. As will also be shown below, process 30 can split line items automatically, i.e., without user intervention to prevent bottlenecks in shipments.

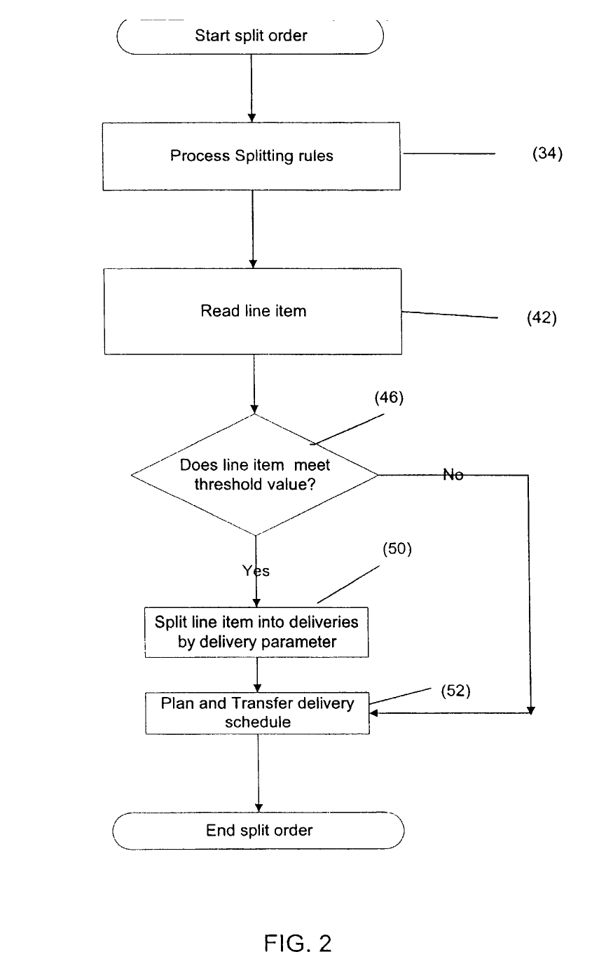

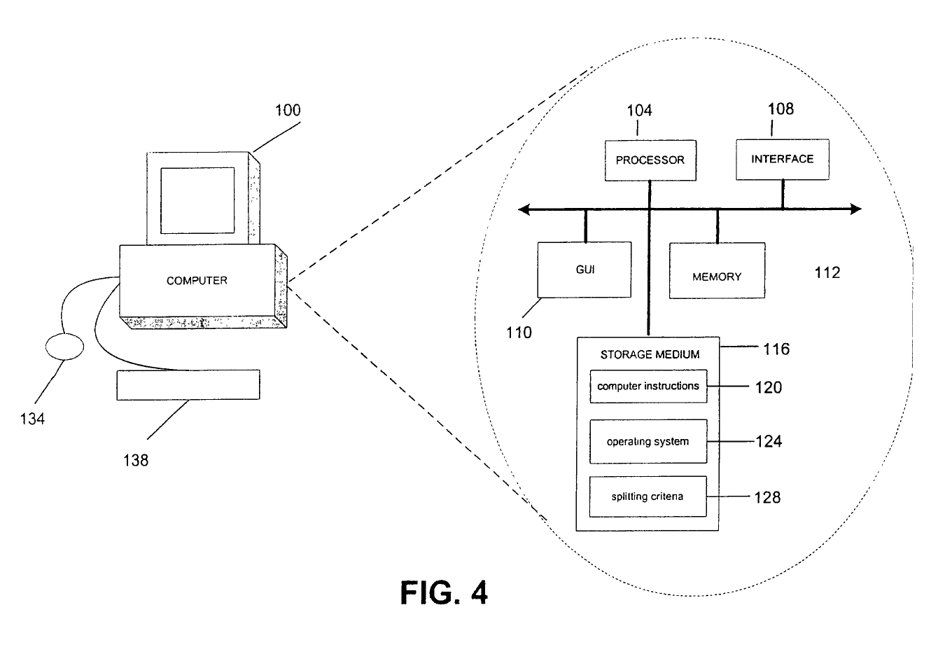

Referring to FIG. 2, process 30 processes (34) splitting criteria (128) within planning function 22 (FIG. 4). Process 30 can generate new splitting criteria, modify existing splitting criteria, or delete existing splitting criteria. The splitting criteria include a threshold value and a delivery parameter. The threshold value is the type and value that determines when splitting deliveries will occur. For example, the threshold value can be a weight value (e.g., 50 tons) or a quantity value (e.g., 50 widgets).

The delivery parameter designates at what type and at what increments to ship the delivery. For example, a delivery parameter is a weight value (e.g., 25 tons) or a quantity value (e.g., 25 widgets).

Thus, for example, a threshold value is 20 tons and the delivery parameter is 10 tons. If the line item is 100 tons, the splitting criteria are used (i.e., the line item exceeds the threshold value). The line item would be split in increments of 10 tons each equal to the delivery parameter.

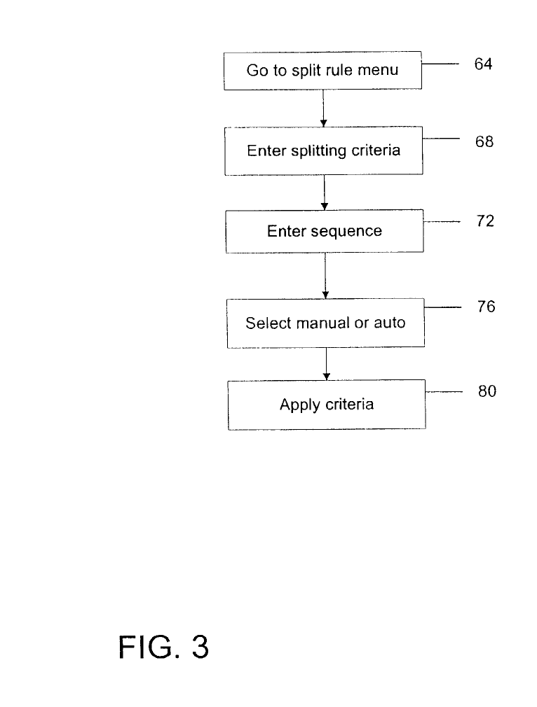

Referring to FIG. 3, a process 60 is an example of the actions a user performs to enter splitting criteria into planning function 22. A user goes (64) to a split-rule menu in planning function 22. A user enters (68) the threshold value and the delivery parameter. The user enters (72) a sequence in which the split rules are to be accessed. For example, a user can choose whether the threshold value is accessed before the delivery parameter. The user selects (76) whether the split criteria will be applied automatically or manually. The user applies (80) the criteria by clicking an apply field.

Referring back to FIG. 2 process 30 reads (42) the line item delivery requirements from the sales order. Process 30 determines (46) if the line item meets the threshold value. If the threshold value is met, process 30 splits (50) the line item into multiple deliveries. The deliveries are planned in increments of the delivery parameters. If the threshold value is not met, process 30 bypasses splitting deliveries.

If the line items are split, process 30 plans (52) the deliveries for each line item and sub-line items for split orders and transfers (52) the delivery schedule to order entry and execution 14 for subsequent shipment and delivery execution.

In one embodiment for planning function 22 used in transportation planning, planning and transferring (52) a delivery schedule includes selecting a carrier to ship each delivery, tendering the shipment to the carrier, and generating the required shipping documents for each shipment that a carrier accepts to ship.

FIG. 4 shows a computer 100 for splitting a line item using a process 30. Computer 100 includes a processor 104, an interface 108, a graphical user interface (GUI) 110, a memory 112, and a storage medium 116 (e.g., hard disk). Storage medium 116 stores operating system 124, splitting criteria 128 for splitting line items, and computer instructions 120 which are executed by processor 104 out of memory 112 to perform process 30. Splitting criteria 128 are loaded by a user using GUI 110 through a keyboard 138 or a mouse 134.

Process 30 is not limited to use with the hardware and software of FIG. 4; it may find applicability in any computing or processing environment and with any type of machine that is capable of running a computer program. Process 30 may be implemented in hardware, software, or a combination of the two. For example, process 30 may be implemented in a circuit that includes one or a combination of a processor, a memory, programmable logic and logic gates. Process 30 may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform process 30 and to generate output information.

Each such program may be implemented in a high level procedural or object-oriented programming language to communicate with a computer system. However, the programs can be implemented in assembly or machine language. The language may be a compiled or an interpreted language. Each computer program may be stored on a storage medium or device (e.g., CD-ROM, hard disk, or magnetic diskette) that is readable by a general or special purpose programmable computer for configuring and operating the computer when the storage medium or device is read by the computer to perform process 30. Process 30 may also be implemented as a machine-readable storage medium, configured with a computer program, where upon execution, instructions in the computer program cause the computer to operate in accordance with process 30.

The process is not limited to the specific embodiments described herein. For example, the splitting criteria can be generated automatically instead of manually. In this embodiment, initial parameters are loaded in once and process 30 generates and modifies the splitting criteria based on the particular delivery requirements. The initial parameters can include the limitations (e.g., weight, size) at a particular shipping location. The process is not limited to the specific processing order of FIGS. 2 and 3. Rather, the blocks of FIGS. 2 and 3 may be re-ordered, as necessary, to achieve the results set forth above.

Other embodiments not described herein are also within the scope of the following claims.

What is claimed is:

1. A method of splitting a line item in an order, comprising:
storing a first criteria, for splitting the line item into a plurality of deliveries, and a second criteria; and
generating the plurality of deliveries according to the first criteria.

2. The method of claim 1, wherein the second criteria comprises:
a threshold value.

3. The method of claim 2, further comprising:
determining if the line item meets the threshold value.

4. The method of claim 3, wherein the threshold value comprises units of weight.

5. The method of claim 3, wherein the threshold value comprises a quantity.

6. The method of claim 1, wherein the criteria comprises:
a delivery parameter.

7. The method of claim 6, wherein the delivery parameter comprises units of weight.

8. The method of claim 6, wherein the delivery parameter comprises a quantity.

9. The method of claim 6, wherein generating the plurality of deliveries comprises:
delivering at least one shipment in an increment equal to the delivery parameter.

10. The method of claim 2, wherein generating the plurality of deliveries comprises:
determining if the line item satisfies the second criteria;
splitting the line item into the plurality of deliveries when the item satisfies the second criteria.

11. An apparatus comprising:
a memory that stores executable instructions for splitting a line item in an order into a plurality of deliveries; and
a processor that executes the instructions to:
store a first criteria, for splitting the line item into a plurality of deliveries, and a second criteria; and
generate the plurality of deliveries according to the first criteria.

12. The apparatus of claim 11, wherein the second criteria comprises:
a threshold value.

13. The apparatus of claim 12, further comprising:
determining if the line item meets the threshold value.

14. The apparatus of claim 13, wherein the threshold value comprises units of weight.

15. The apparatus of claim 13, wherein the threshold value comprises a quantity.

16. The apparatus of claim 11, wherein the criteria comprises:
a delivery parameter.

17. The apparatus of claim 16, wherein the delivery parameter comprises units of weight.

18. The apparatus of claim 16, wherein the delivery parameter comprises a quantity.

19. The apparatus of claim 16, wherein delivering the plurality of deliveries comprises:
delivering at least one shipment in an increment equal to the delivery parameter.

20. The apparatus of claim 12, wherein delivering the plurality of deliveries comprises:
determining if the line item satisfies the second criteria;
splitting the line item into the plurality of deliveries when the item satisfies the second criteria.

21. An article comprising a machine-readable medium that stores executable instructions for splitting a line item in an order into a plurality of deliveries, the instructions causing a machine to:
store a first criteria, for splitting the line item into a plurality of deliveries, and a second criteria; and
deliver the plurality of deliveries according to the first criteria.

22. The article of claim 21, wherein the second criterid comprises:
a threshold value.

23. The article of claim 22, further comprising:
determining if the line item meets the threshold value.

24. The article of claim 23, wherein the threshold value comprises units of weight.

25. The article of claim 23, wherein the threshold value comprises a quantity.

26. The article of claim 21, wherein the criteria comprises:
a delivery parameter.

27. The article of claim 26, wherein the delivery parameter comprises units of weight.

28. The article of claim 26, wherein the delivery parameter comprises a quantity.

29. The article of claim 26, wherein delivering the plurality of deliveries comprises:
delivering at least one shipment in an increment equal to the delivery parameter.

30. The article of claim 22, wherein delivering the plurality of deliveries comprises:
determining if the line item satisfies the second criteria;
splitting the line item into the plurality of deliveries when the item satisfies the second criteria.
